(19) United States
(12) Patent Application Publication
(10) Pub. No.: US 2010/0210030 A1
(43) Pub. Date: Aug. 19, 2010

(54) ASSEMBLY OF SEMICONDUCTOR NANOPARTICLE PHOSPHORS, PREPARATION METHOD OF THE SAME AND SINGLE-MOLECULE OBSERVATION METHOD USING THE SAME

(75) Inventors: Kazuyoshi Goan, Kanagawa (JP); Kumiko Nishikawa, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 12/668,446

(22) PCT Filed: Jun. 16, 2008
(86) PCT No.: PCT/JP2008/060969

§ 371 Date: Jan. 11, 2010

(30) Foreign Application Priority Data
Jul. 18, 2007 (JP) 2007186777

(51) Int. Cl. C09K 11/59; C09K 11/66; G01N 21/64

(52) U.S. Cl. 436/172; 252/301.4 F; 252/301.4 R

(57) ABSTRACT

Disclosed are an assembly of semiconductor nanoparticle phosphors, which can provide stable evaluation without variation in emission wavelength or in intensity of emission among the particles when used as a labeling agent through which a single-molecule observation is carried out, a preparation method of the assembly, and a single-molecule observation method employing the assembly. Also disclosed is a method for preparing an assembly of semiconductor nanoparticle phosphors according to a liquid phase method, the method comprising the step of reacting a semiconductor precursor at a temperature which is not lower than the melting point of the semiconductor precursor and is not higher than the boiling point of a solvent.

### FIELD OF THE INVENTION

The present invention relates to an assembly of semiconductor nanoparticle phosphors, a preparation method of the assembly, and a single-molecule observation method using the assembly.

### TECHNICAL BACKGROUND

In recent years, a highly sensitive detector or a labeling agent providing a high luminance enables detection, identification, and dynamic observation of a single-molecule, which has played a major roll in analytical chemistry, molecular biology and analysis of nanostructures.

Fluorescent dyes or nanoparticle phosphors have been proposed as a labeling agent used in observation of a single-molecule. Especially, such nanoparticle phosphors are advantageous as compared with the fluorescent dyes. When the size or material of the nanoparticle phosphors is appropriately selected, the nanoparticle phosphors make it possible to set relatively freely a wavelength providing an emission peak in the range of from 400 to 2000 nm, and enlarge the stokes shift, which minimizes overlap of the emission light with an excitation light or adverse affect due to background noises, whereby the detection capability is enhanced. Further, the nanoparticle phosphors enable long-term observation of a moving substance since the phosphors cause little discoloration.

A material, which is a semiconductor material of nanometer size and exhibits a quantum confinement effect, is referred to as “a quantum dot”. Such a quantum dot is a tiny agglomerate of at most ten-odd nm, which is composed of several hundreds to several thousands of semiconductor atoms, but emits energy corresponding to the energy band gap of the quantum dot when it reaches an energy excitation state via absorption of light from an excitation source. Accordingly, it is considered that the energy band gap can be adjusted by selecting the size or material composition of the quantum dot, which makes it possible to employ energy at various wavelength bands.

However, the quantum dot has a crystal structure and a property of changing the band gap depending on the particle size. Since change of the band gap changes the wavelength of emitted light, variation of the particle sizes of individual particles results in variation of emission spectra of the individual particles. In order to overcome such variation, an extra process of classifying particles so as to provide single emission spectra is required, which is quite problematic. Various other preparation methods of the nanoparticles have been proposed, but they are not necessarily suitable as a preparation method of semiconductor nanoparticle phosphors, or are not sufficient in solving the problem of the variation as described above (see for example, Patent Documents 1 through 3 and Non-Patent Document 1 below).

An assembly of semiconductor nanoparticle phosphors, which has been used in practice, has a particle size distribution and exhibits variation in emission spectra and luminance depending on the individual particles. Therefore, the assembly has problem in that when a single-molecule observation is carried out, stable evaluation is difficult.

Patent Document 1: Japanese Patent O.P.I. Publication No. 2003-193119

Patent Document 2: Japanese Patent O.P.I. Publication No. 2003-239006

Patent Document 3: Japanese Patent O.P.I. Publication No. 2000-54012

Non-Patent Document 1: J. H. Warner, H. R-Dunlop, and R. D. Tilly; J. Phys. Chem. B, 109, 19064-19067 (2005)

### DISCLOSURE OF THE INVENTION

### Problems to be Solved by the Invention

The present invention has been made in view of the above. An object of the invention is to provide an assembly of semiconductor nanoparticle phosphors, which can provide stable evaluation without variation in emission wavelength or in intensity of emission among the particles when used as a labeling agent through which a single-molecule observation is carried out, a preparation method of the assembly, and a single-molecule observation method employing the assembly.

### Means for Solving the Above Problems

In order to attain the above object, the present inventors have made an extensive study on the state of a semiconductor precursor in a solvent to form a semiconductor. As a result, they have found that an assembly of monodisperse nanoparticles is formed extremely efficiently by reacting a semiconductor precursor at a temperature of not lower than the boiling point of the semiconductor precursor, and completed the present invention.

The present invention has been attained by the following constitutions.

1. A method for preparing an assembly of semiconductor nanoparticle phosphors according to a liquid phase method, the method comprising the step of reacting a semiconductor precursor at a temperature which is not lower than the melting point of the semiconductor precursor and is not higher than the boiling point of a solvent.

2. The method for preparing an assembly of semiconductor nanoparticle phosphors of item 1 above, the method comprising a step of reducing the semiconductor precursor according to reduction reaction.

3. The method for preparing an assembly of semiconductor nanoparticle phosphors of item 1 or 2 above, the method comprising a step of reacting the semiconductor precursor in the presence of a surfactant.

4. An assembly of semiconductor nanoparticle phosphors prepared according to the method for preparing an assembly of semiconductor nanoparticle phosphors of any one of items 1 through 3 above.

5. The assembly of semiconductor nanoparticle phosphors of item 4 above, the assembly having an average particle size of from 1 to 10 nm.

6. The assembly of semiconductor nanoparticle phosphors of item 4 or 5 above, wherein the assembly contains Si or Ge as a component of the semiconductor nanoparticle phosphors.

7. A single-molecule observation method comprising the steps of labeling a molecule with the assembly of semiconductor nanoparticle phosphors of any one of items 4 through 6 above; exposing the labeled molecule to excitation light; and detecting light emitted from the exposed molecule, thereby identifying the molecule.

8. The single-molecule observation method of item 7 above, comprising the steps of labeling each of plural kinds of molecules with semiconductor nanoparticle phosphors each having different emission spectra; and irradiating each of the labeled molecules with excitation light, thereby simultaneously identifying the plural kinds of molecules.

### Effects of the Invention

The present invention can provide an assembly of semiconductor nanoparticle phosphors, which can provide stable evaluation without variation in emission wavelength or in intensity of emission among the particles when used as a labeling agent through which a single-molecule observation is carried out, a preparation method of the assembly, and a single-molecule observation method employing the assembly.

### PREFERRED EMBODIMENT OF THE INVENTION

The preparation method of the assembly of semiconductor nanoparticle phosphors of the invention is a preparation method according to a liquid phase method, which is characterized in that it comprises a step of reacting a semiconductor precursor at a temperature identical to or higher than the melting point of the semiconductor precursor and at a temperature identical to or lower than the boiling point of a solvent. This characteristic is a technical property common to the constitutions of items 1 through 8 above.

In the invention, it is preferred that the preparation method comprises a step of reducing the semiconductor precursor due to reduction reaction. Further, it is preferred that the preparation method comprises a step of reacting the semiconductor precursor in the presence of a surfactant.

The preparation method of the assembly of semiconductor nanoparticle phosphors of the invention is suitable as a preparation method of an assembly of semiconductor nanoparticle phosphors having an average particle size of from 1 to 10 nm, and is especially suitable as a preparation method of an assembly of semiconductor nanoparticle phosphors containing Si or Ge.

The semiconductor nanoparticle phosphors prepared according to the method described above can be applied to a single molecule observation method which detects light emitted when a molecule labeled with the semiconductor nanoparticle phosphors is subjected to excitation light, thereby identifying the molecule. The semiconductor nanoparticle phosphors are especially suitable to a single molecule observation method, which simultaneously identifies plural kinds of molecules by irradiating, with excitation light, the plural kinds of molecules each labeled with semiconductor nanoparticle phosphors each having different emission spectra.

“An assembly of semiconductor nanoparticle phosphors” according to the invention refers to a dispersion (including a solution or a suspension) containing semiconductor nanoparticle phosphors, a powder composed of semiconductor nanoparticle phosphors or a sheet containing dispersed semiconductor nanoparticle phosphors.

Next, the invention and its constituent elements will be explained in detail.

### (Materials for Semiconductor Nanoparticle Phosphors)

The semiconductor nanoparticle phosphors in the invention can be prepared employing various semiconductor materials. Examples thereof include semiconductor compounds comprising elements of Group IV, elements of Groups II and VI or elements of Groups III and V in the periodic table.

Examples of semiconductors comprising elements of Groups II and VI include MgS, MgSe, MgSe, MgTe, CaS, CaSe, CaTe, SrS, SrSe, SrTe, BaS, BaSe, BaTe, ZnS, ZnSe, ZnTe, CdS, CdSe, HgS, HgSe, and HgTe.

Among semiconductors comprising elements of Groups III and V, GaAs, GaN, GaPGaSb, InGaAs, InP, InN, InSb, InAs, AlAs, AlP, AlSb, and AlS are preferred.

Among semiconductors comprising Group IV elements, Ge, Pb and Si are especially suitable.

In the invention, semiconductor nanoparticle phosphors are preferably ones having a core/shell structure. In this case, the semiconductor nanoparticle phosphors are composed of semiconductor nanoparticles having a core/shell structure which comprise a core comprised of semiconductor microparticles covered with a shell, and are preferably those in which the chemical composition of the core is different from that of the shell.

As the semiconductor material used in the core, there are various semiconductor materials. Examples thereof include MgS, MgSe, MgTe, CaS, CaSe, CaTe, SrS, SrSe, SrTe, BaS, BaTe, ZnS, ZnSe, ZnTe, CdS, CdSe, CdTe, GaAs, GaP, GaSb, InGaAs, InP, InN, InSb, InAs, AlAs, AlP, AlSb, AlS, PbS, PbSe, Ge, Si, and an admixture thereof. In the invention, Si or Ge is especially preferred. A doping material such as Ga may be contained in a small amount as necessary.

Various semiconductor materials can be used as semiconductor materials used in the shell. Typical examples of the semiconductor materials include ZnO, ZnS, ZnSe, ZnTe, CdO, CdS, CdSe, CdTe, MgS, MgSe, GaS, GaN, GaP, GaAs, GaSb, InAs, InN, InP, InSb, AlAs, AlN, aluminum plate and AlSb. In the invention, especially preferred semiconductor material is SiO₂ or ZnS.

In the invention, the entire core surface is not necessarily required to be covered with the shell as long as the core whose surface is partially exposed causes no adverse effect.

The average particle size of the semiconductor nanoparticle phosphors in the invention is preferably from 1 to 10 nm.

In the invention, the average particle size of the semiconductor nanoparticle phosphors should be determined in terms of three dimensions, but the determination is difficult since the phosphors are too small, and actually, the average particle size is determined employing a two-dimensional particle image. It is preferred that particles at various portions are photographed employing a transmission electron microscope (TEM) to obtain many electron micrographs of the particles, and the average particle size is determined from them. Accordingly, in the invention, the particle sizes of the sections of many particles in the electron micrographs photographed by TEM are measured, and the arithmetic average thereof is determined as an average particle size. Herein, a diameter of a circle having the same area as the measurement is defined as a particle size. The number of the particles to be photographed by TEM is preferably not less than 100, and more preferably 1000. In the invention, an average of the particle sizes of 1000 particles is defined as the average particle size of the particles.

### <Preparation Method of Assembly of Semiconductor Nanoparticle Phosphors>

As the preparation method of the assembly of semiconductor nanoparticle phosphors of the invention, there can be used various known methods. The method can be largely classified into a liquid phase method and gas phase method. In the invention, the liquid phase method is employed.

As the preparation methods according to a liquid phase method, there are a precipitation method, a co-precipitation method, a sol-gel method, a uniform precipitation method, and a reduction method. In addition, a reverse micelle method and a super critical water thermal synthesis method is an excellent method in preparing nanoparticles (see, for example, Japanese Patent O.P.I. Publication Nos. 2002-322468, 2005-239775, 10-310770 and 2000-104058).

The semiconductor precursor in the invention is a compound comprising the elements used in the semiconductor materials described above. For example, when the semiconductor is Si, examples of the semiconductor precursor include SiCl₄. Other examples of the semiconductor precursor include InCl₃, P(SiMe₃)₃, ZnMe₂, CdMe₂, GeCl₄, and selenium-tributylphosphine.

The reaction temperature of the semiconductor precursor is not specifically limited, as long as it is a temperature identical to or higher than the boiling point of the semiconductor precursor used and a temperature identical to or lower than the boiling point of the solvent used, but it is preferably from 70 to 110° C.

### (Reducing Agent)

As a reducing agent for reducing the semiconductor precursor in the invention, various kinds of known reducing agents are selected according to reaction conditions and employed. In the invention, lithium aluminum hydride (LiAlH₄), sodium boron hydride (NaBH₄), sodium bis(2-methoxyethoxy) aluminum hydride, lithium tri(sec-butyl) boron hydride (LiBH(sec-C₄H₉)₃), potassium tri (sec-butyl) boron hydride or lithium triethyl boron hydride is preferred in view of reduction capability, and lithium aluminum hydride (LiAlH₄) is especially preferred in view of strong reduction capability.

### (Solvent)

As a dispersion solvent of the semiconductor precursor in the invention, various kinds of known solvents can be employed. As the solvent, an alcohol such as ethyl alcohol, sec-butyl alcohol or t-butyl alcohol and a hydrocarbon solvent such as toluene, decade or hexane is preferably employed. In the invention, a hydrophobic solvent such as toluene is especially preferred as the dispersion solvent.

### (Surfactant)

As the surfactant in the invention, various known surfactants can be used, which include an anionic surfactant, a nonionic surfactant, a cationic surfactant and an amphoteric surfactant. Among the surfactants, a quaternary ammonium salt such as tetrabutylammonium chloride, tetrabutylammonium bromide, tetrabutylammonium hexafluorophosphate, tetraoctylammonium bromide (TOAB) or tributylhexadecylphosphonium bromide is preferred, and tetraoctylammonium bromide is especially preferred.

Reaction according to the liquid phase method greatly varies depending on compounds including a solvent in a solution. Special attention should be made to prepare monodisperse nanosized particles. In a reverse micelle method, for example, conditions under which the nanoparticles are formed are restricted, since the size or state of the reverse micelle as a reaction site varies depending on concentration or kinds of a surfactant used. Accordingly, an appropriate combination of a surfactant and a solvent is required.

### (Application Examples)

The semiconductor nanoparticle phosphor of the invention can be applied to analysis of a single molecule in various technical fields. In the single molecule observation method, for example, plural kinds of molecules can be simultaneously identified when the plural kinds of molecules are labeled with semiconductor nanoparticle phosphors having different emission spectra and subjected to excitation light radiation. The plural kinds of molecules applicable to this method include structural isomers having the same chemical composition but different chemical structural formulas.

Next, typical application examples will be explained.

### (Biological Substance Labeling Agent and Bioimaging)

The semiconductor nanoparticle phosphor assembly of the invention is applicable to a biological substance fluorescent labeling agent. Further, when added to a living cell or a living body having a target (trace) substance, a biological substance labeling agent in the invention is bonded or adsorbed to the target substance. Thereafter, the resulting bonded or adsorbed body is irradiated with excitation light of a predetermined wavelength and then fluorescence of a specific wavelength emitted from the fluorescent semiconductor nanoparticles based on the excitation light is detected, whereby dynamic fluorescence imaging of the target (trace) substance can be carried out. That is the biological substance labeling agent in the invention can be applied to a bioimaging method (a technological method to visualize biological molecules constituting a biological substance and dynamic phenomena thereof).

### [Hydrophilization of Assembly of Semiconductor Nanoparticle Phosphors]

The surface of the assembly of semiconductor nanoparticle phosphors described above is generally hydrophobic. For example, the assembly, when used as a biological substance labeling agent, exhibits poor water dispersibility, resulting in aggregation of particles which is problematic. Therefore, the surface of the shell of core/shell type semiconductor nanoparticle phosphors is preferably hydrophilized.

As a hydrophilization method, there is, for example, a method wherein after oleophilic groups on the surface of the particles are removed with pyridine, etc, a surface modifier is chemically and/or physically combined with the particle surface. As the surface modifier, those containing a carboxyl group or an amino group as a hydrophilic group are preferably used. Typical examples thereof include mercaptopropionic acid, mercaptoundecanoic acid, and aminopropane thiol. Specifically, for example, 10⁻⁵ g of Ge/GeO₂ type nanoparticles are dispersed in 10 ml of pure water dissolving 0.2 g of mercaptoundecanoic acid, and stirred at 40° C. for 10 minutes to surface-treat the shell surface, whereby the surface of the inorganic nanoparticle shell can be modified with a carboxyl group.

### [Biological Substance Labeling Agent]

The biological substance labeling agent in the present invention is obtained by combining the above hydrophilized semiconductor nanoparticle phosphors with a molecule labeling agent via an organic molecule.

### <Molecule Labeling Agent>

In the invention, the molecule labeling agent of the biological substance labeling agent is specifically combined with and/or reacted with, a targeted biological substance, whereby the biological substance labeling agent can label the biological substance.

Examples of the molecule labeling agent include a nucleotide chain, an antibody, an antigen and, cyclodextrin.

### <Organic Molecule>

In the biological substance labeling agent according to the present invention, the hydrophilized semiconductor nanoparticle phosphors are combined with the molecule labeling agent through an organic molecule. The organic molecule is not specifically limited, as long as it is one capable of combining with the semiconductor nanoparticle phosphors and with the molecule labeling agent. Preferred examples of the organic molecule include proteins such as albumin, myoglobin and casein, and one kind of protein, avidin which is used in combination with biotin. A bonding manner through which the nanoparticles are combined with the molecule labeling agent via the organic molecule as described above, although not specifically limited, includes covalent bonding, ionic bonding, hydrogen bonding, coordination bonding, physical adsorption or chemical adsorption. From the viewpoint of bonding stability, bonding featuring a strong bonding force such as covalent bonding is preferred.

Specifically, when the semiconductor nanoparticle phosphors are hydrophilized with mercaptoundecanoic acid, avidin and biotin can be used as the organic molecules. In this case, the carboxyl group of the hydrophilized nanoparticles is suitably covalently combined with avidin, which is then selectively combined with biotin, the biotin being further combined with a biological substance labeling agent to obtain a biological substance labeling agent.

### EXAMPLES

The present invention will be explained in detail in the following examples, but is not limited thereto.

### Example 1

### Preparation of Assembly of Si Nanoparticles

Three grams of tetraoctylammonium bromide (TOAD) were dissolved in 200 ml of toluene. SiCl₄ of 184 μl was added to the resulting solution while stirring at room temperature. One hour after the addition, 0.004 mole of lithium aluminum hydride was dropwise added to the solution at a temperature as shown in Table 1 to conduct reduction reaction. Three hours after the addition, 40 ml of methanol were added thereto to deactivate the excessive reducing agent and allylamine was added with a platinum catalyst. The solvent of the resulting mixture solution was removed employing a rotary evaporator. The residue was washed with methylformamide and pure water several times. Thus, a Si nanoparticle dispersion sample was obtained in which Si particles were dispersed in pure water.

The boiling point of the semiconductor precursor, SiCl₄ is 57.6° C., and the boiling point of the solvent, toluene is 110.6° C.

### (Measurement of Particle Distribution)

The dispersion sample obtained above was photographed by a TEM to obtain a TEM image of the nanoparticles. The particle sizes of 1000 particles in the TEM image were measured and the average thereof was determined as the average particle size of the nanoparticles in the dispersion sample.

### (Crystallinity)

A part of Si nanoparticles before dispersed in water was subjected to Raman scattering measurement employing a 515 nm argon ion laser. The sharp peak at 520 cm⁻¹ derived from crystalline silicon and abroad peak derived from amorphous silicon were observed. The amorphous peak intensity relative to the crystal peak intensity being 1 is shown in Table 1. The smaller the amorphous peak intensity is, the higher the crystallinity.

### (Fluorescence Quantum Yield)

The nanoparticle dispersion samples obtained above were each exposed to an excitation light at a wavelength of 350 nm, and emitted fluorescence spectrum was measured. A relative quantum yield of each sample was determined from a molar absorption coefficient obtained from an absorption spectrum of a sample, a wave number integrated value of a fluorescence spectrum and a refractive index of a solvent each being represented by a relative value based on those of dispersion sample 1.

A quantum yield Φₓ of a sample can be determined by the following formula:

ΦₓFₓnₓ²/Fᵣnᵣ²·sᵣcᵣdᵣ/sₓcₓdₓ·Φᵣ (A)

wherein Φᵣ is the quantum yield of a standard reference material, Fₓ the wave number integrated value of a sample, nₓ the refractive index of a solvent of a sample, sₓcₓdₓ the absorbance of a sample, Fᵣ the wave number integrated value of a standard reference material, nᵣ the refractive index of a solvent of a standard reference material, and sᵣcᵣdᵣ the absorbance of a standard reference material.

The evaluation results are shown in Table 1, in which the relative quantum yield of each sample is represented by a relative value, based on the relative quantum yield of dispersion sample 1 being 1.0.

### (Single-Molecule Observation)

When the respective dispersion samples were exposed to a 350 nm excitation light and excited, emission spectra of each of the particles in the samples were observed, employing a near field scanning optical microscope. Emission spectra of one hundred particles in each of the dispersion samples were observed, and standard deviation of intensity of emission (peak intensity) at a wavelength providing emission maximum was computed. The results are shown in Table 1, together with the variation range of the wavelength providing emission maximum.

TABLE 1

| | | Average | | | | | |
|---|---|---|---|---|---|---|---|
| | Reaction | particle | | | | | |
| Sample | Temperature | size | | | (*4) | | |
| No. | (° C.) | (nm) | Crystallinity | (*3) | (*5) | (*6) | Remarks |
| 1 | 20 | 2.5 | (*1) | 1.0 | 40 | 60 | Comp. |
| 2 | 30 | 2.5 | 20 | 1.0 | 42 | 50 | Comp. |
| 3 | 40 | 2.5 | 18 | 1.2 | 38 | 55 | Comp. |
| 4 | 50 | 2.5 | 15 | 1.0 | 40 | 50 | Comp. |
| 5 | 60 | 2.4 | 0.2 | 4.5 | 10 | 8 | Inv. |
| 6 | 70 | 2.5 | 0 | 5.6 | 5 | 5 | Inv. |
| 7 | 80 | 2.5 | 0 | 5.5 | 3 | 3 | Inv. |
| 8 | 90 | 2.5 | 0 | 5.0 | 4 | 3 | Inv. |
| 9 | 100 | 2.6 | 0 | 5.5 | 5 | 4 | Inv. |
| 10 | 120 | 15.8 | (*1) | (*2) | (*2) | (*2) | Comp. |

Comp.: Comparative,
Inv.: Inventive
(*1): Only amorphous peaks were observed.
(*2): No emission spectra were observed.
(*3): Fluorescence Quantum Yield;
(*4): Single Molecule Observation;
(*5): Standard Deviation of Intensity of Emission;
(*6): Standard Deviation of Wavelength Providing Emission Maximum.

The assembly of semiconductor nanoparticle phosphors of the invention provides a low standard deviation of intensity of emissionₛ minimizing variation of intensity of emission among the particles. It has proved that the assembly of semiconductor nanoparticle phosphors of the invention is excellent as a labeling agent for single-molecule observation.

### Example 2

1×10⁻⁵ g of each of the assemblies of Si semiconductor nanoparticle phosphors prepared in Example 1 were re-dispersed in 10 ml of pure water in which 0.2 g of mercaptoundecanoic acid were dissolved, and stirred at 40° C. for 10 minutes to obtain surface-hydrophilized nanoparticles.

Then, each of the resulting dispersions containing surface-hydrophilized nanoparticles was added with 25 mg of avidin and stirred at 40° C. for 10 minutes to prepare avidin-conjugate nanoparticles.

A biotinylated oligonucleotide having a known base sequence was mixed with the above-obtained avidin-conjugate nanoparticle solution with stirring to prepare a nanoparticle-labeled oligonucleotide.

The above labeled oligonucleotide was dropped onto a DNA chip tightly holding oligonucleotides having various base sequences, followed by washing. It was confirmed that when the resulting chip was subjected to ultraviolet light irradiation, only the spot of an oligonucleotide having a base sequence complementary to that of the labeled oligonucleotide emitted light with different color, depending on the particle size of the semiconductor nanoparticles

It was confirmed from the above that labeling of oligonucleotide with the semiconductor nanoparticle phosphors in the invention was possible.

1. A method for preparing an assembly of semiconductor nanoparticle phosphors according to a liquid phase method, the method comprising the step of:
reacting a semiconductor precursor in a solvent at a temperature which is not lower than the melting point of the semiconductor precursor and is not higher than the boiling point of the solvent.

2. The method for preparing an assembly of semiconductor nanoparticle phosphors of claim 1, comprising a step of reducing the semiconductor precursor in the presence of a reducing agent.

3. The method for preparing an assembly of semiconductor nanoparticle phosphors of claim 1, comprising a step of reacting the semiconductor precursor in the presence of a surfactant.

4. An assembly of semiconductor nanoparticle phosphors prepared according to the method for preparing an assembly of semiconductor nanoparticle phosphors claim 1.

5. The assembly of semiconductor nanoparticle phosphors of claim 4, the assembly having an average particle size of from 1 to 10 nm.

6. The assembly of semiconductor nanoparticle phosphors of claim 4, wherein the assembly contains Si or Ge as a component of the semiconductor nanoparticle phosphors.

7. A single-molecule observation method comprising the steps of:
labeling a molecule with the assembly of semiconductor nanoparticle phosphors of claim 4;
exposing the labeled molecule to excitation light; and
detecting light emitted from the exposed molecule, thereby identifying the molecule.

8. The single-molecule observation method of claim 7, comprising the steps of:
labeling each of plural kinds of molecules with semiconductor nanoparticle phosphors each having different emission spectra; and
irradiating each of the labeled molecules with excitation light, thereby simultaneously identifying the plural kinds of molecules.

9. The method for preparing an assembly of semiconductor nanoparticle phosphors of claim 1, wherein the temperature is from 70 to 110° C.

10. The method for preparing an assembly of semiconductor nanoparticle phosphors of claim 1, wherein the semiconductor precursor is a compound comprising elements of Group IV, elements of Groups II and VI or elements of Groups III and V in the periodic table.

11. The method for preparing an assembly of semiconductor nanoparticle phosphors of claim 10, wherein the semiconductor precursor is a compound selected from SiCl₄, InCl₃, P(SiMe₃)₃, ZnMe₂, CdMe₂, GeC₄, and selenium-tributylphosphine.

12. The method for preparing an assembly of semiconductor nanoparticle phosphors of claim 2, wherein the reducing agent is LiAlH₄.

13. The method for preparing an assembly of semiconductor nanoparticle phosphors of claim 3, wherein the surfactant is a quaternary ammonium salt.

14. The method for preparing an assembly of semiconductor nanoparticle phosphors of claim 13, wherein the quaternary ammonium salt is tetraoctylammonium bromide.
